(19) United States
(12) Patent Application Publication
(10) Pub. No.: US 2014/0360014 A1
(43) Pub. Date: Dec. 11, 2014

(54) METHOD FOR PRODUCING A BUILT HOLLOW VALVE OF AN INTERNAL COMBUSTION ENGINE

(71) Applicant: Mahle International GmbH, Stuttgart (DE)

(72) Inventors: Peter Kroos, Rutesheim (DE); Christoph Luven, Stuttgart (DE); Alexander Mueller, Wildberg (DE); Alexander Puck, Esslingen (DE)

(21) Appl. No.: 14/301,614

(22) Filed: Jun. 11, 2014

(30) Foreign Application Priority Data
Jun. 11, 2013 (DE) 102013210897.4

(51) Int. Cl. B23P 15/00

(52) U.S. Cl. CPC B23P 15/002
USPC 29/888.45

(57) ABSTRACT

A method for producing a hollow valve of an internal combustion engine may include providing a valve stem and a valve disc having a valve bottom and a valve cone; placing the valve bottom centrally in a mounting of an assembly device; holding the valve stem via a holding device; concentrically placing the valve stem onto the valve bottom and rotating the valve stem together with the valve bottom; welding the valve stem to the valve bottom; pushing the valve cone over the valve stem until the valve stem contacts the valve bottom; welding the valve cone together with the valve bottom; and welding the valve cone together with the valve stem.

### CROSS-REFERENCE TO RELATED APPLICATIONS

This application claims priority to German Patent Application DE 10 2013 210 897.4 filed Jun. 11, 2013, which is hereby incorporated by reference in its entirety.

### TECHNICAL FIELD

The present invention relates to a method for producing a built hollow valve of an internal combustion engine.

### BACKGROUND

Hollow valves are preferably employed in modern internal combustion engines so that they not only have a reduced weight, but additionally offer the possibility of accommodating a coolant in hollow spaces of the hollow valve and because of this make possible an optimised cooling of the valve. By cooling the hollow valve its fatigue strength can be significantly increased.

Known hollow valves are produced for example in that initially a valve blank is produced, in particular forged, into which the relevant hollow space is subsequently introduced by means of a bore. A hollow valve produced in this manner however is comparatively complicated and because of this expensive to produce.

### SUMMARY

The present invention therefore deals with the problem of stating a method for producing a built hollow valve of an internal combustion engine, by means of which the hollow valve can be produced economically and with maximum precisions at the same time.

According to the invention, this problem is solved through the subject of the independent claim. Advantageous embodiments are subject of the dependent claims.

The present invention is based on the general idea of stating a new type and efficient method for producing a built hollow valve of an internal combustion engine, which is substantially divided into six method steps a.) to f.). Initially, with the method according to the invention, a valve bottom of a valve disc in the method step a.) is placed centred in a mounting of an assembly device. Following this, a valve stem in the method step b.) is concentrically placed onto the valve bottom by means of a holding device and rotated together with the valve bottom. The valve stem and the valve bottom in this case have a common axis, wherein rotating can be achieved for example through a turnable assembly device. During the rotating, the valve stem is now welded to the valve bottom in a method step c.). Here it can be obviously provided that for welding the valve stem to the valve bottom a laser is used, wherein the latter is fixed and by rotating the valve stem together with the valve bottom the weld seam proceeds. Alternatively it is also conceivable that the laser or a corresponding welding device is rotatably arranged, so that for welding the valve stem together with the valve bottom these two components are stationary and the welding device, i.e. for example the laser, circulates along the valve seam to be produced. If in the process for example two opposite lasers are employed, this offers the great advantage that the two components merely have to be rotated by 180° and not by a full 360° as is the case with only a single laser in order to produce an entirely circumferential weld seam. Because of this, the cycle times can be reduced in particular. In a method step d.) following the method step c.) a valve cone is now pushed over the valve stem until the latter comes in contact with the valve bottom. Following this, this valve cone is welded to the valve bottom in the region of an outer edge, namely in a method step e.). In the following method step f.), the valve cone is now welded together with the valve stem on the opposite end, for example again by means of a laser.

For producing the weld seam between the valve cone and the valve bottom, the valve cone can be preloaded for example against the valve bottom, i.e. pressed against the latter in order to be able to ensure in particular an extremely exact weld. In the same way, an annular region of the valve cone surrounding the valve stem can obviously also be clamped against the valve stem when establishing the weld seam between the valve cone and the valve stem, in particular centred. With the method according to the invention it is possible here that the hollow valve according to the invention can be produced in a high quality and at the same time cost-effectively and process-safely.

In an advantageous embodiment of the solution according to the invention, the valve cone and the valve bottom on sliding the valve cone onto the valve stem are supported in an outer annular region or on an inner annular region. In the first mentioned case, the valve bottom is supported by a corresponding support of the assembly device and on the edge side circumferentially supports itself on this support on an outer edge. Now, the valve cone is pushed over the valve stem and plugged onto the valve bottom. The guide slide, which pushes the valve cone onto the valve stem, in the process supports itself on a circumferential surface of the valve cone, i.e. on an outer edge region. Alternatively to this it is also conceivable that not only the valve cone is pushed onto the valve stem but the valve stem together with the valve bottom is pressed into the valve cone. This thus constitutes only a reversal of the relative movement.

Again alternatively, the valve cone can obviously be gripped by an inner annular region sliding along the valve stem and loaded in order to push the latter onto the valve stem. In this case it is favourable to support the valve bottom in a middle annular region or in a middle region generally, since in this region a direct support for the valve stem can thereby be created.

Further important features and advantages of the invention are obtained from the subclaims, from the drawings and from the associated figure description with the help of the drawings.

It is to be understood that the features mentioned above and still to be explained in the following cannot only be used in the respective combination stated but also in other combinations or by themselves without leaving the scope of the present invention.

Preferred exemplary embodiments of the invention are shown in the drawing and are explained in more detail in the following description, wherein same reference numbers relate to same or similar or functionally same components.

### BRIEF DESCRIPTION OF THE DRAWINGS

It shows, in each case schematically

FIG. 1 method steps a.) and b.) of a method according to the invention for producing a built hollow valve of an internal combustion engine,

FIG. 2 the method step c.), in which the valve stem is welded together with the valve cone,

FIG. 3a-c various embodiments of the method step d.),

FIG. 4 the method step e.),

FIG. 5 the method step f.).

### DETAILED DESCRIPTION

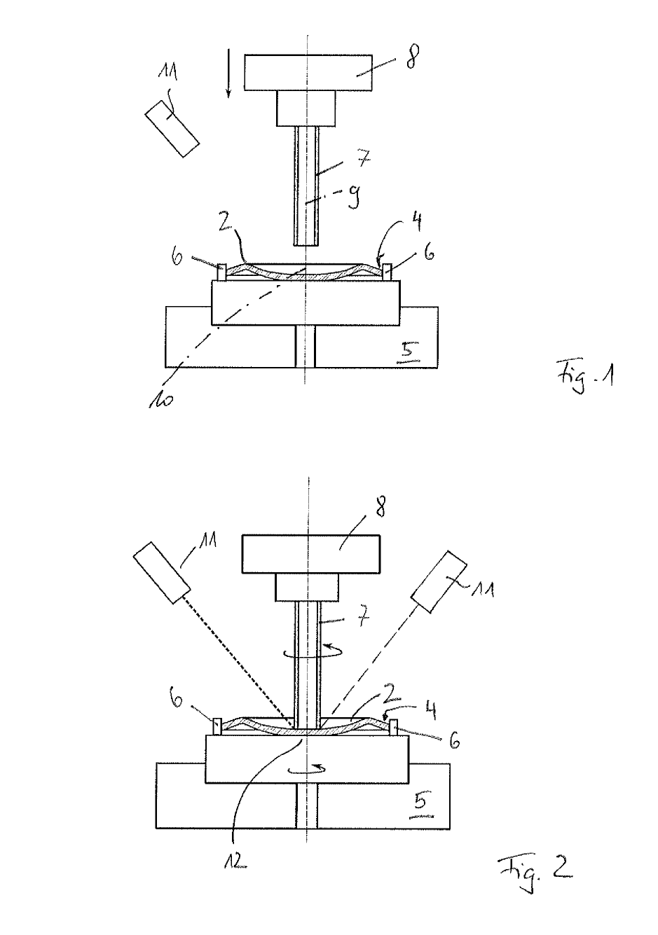

According to FIG. 1, with a method for producing a built hollow valve 1 (see FIG. 5) on an internal combustion engine which is not otherwise shown, a valve bottom 2 of a valve disc 3 (see FIG. 5) in a first method step a.) is placed in a mounting 4 of an assembly device 5 and centred there. Centring can for example take place via a suitable design of the mounting 4, but also via suitable centring elements 6. Following this, a valve stem 7 of the hollow valve 1 is concentrically placed onto the valve bottom 2 by means of a holding device 8. Concentrically in this case means that an axis 9 of the valve stem 7 and an axis 10 of the valve bottom 2 coincide.

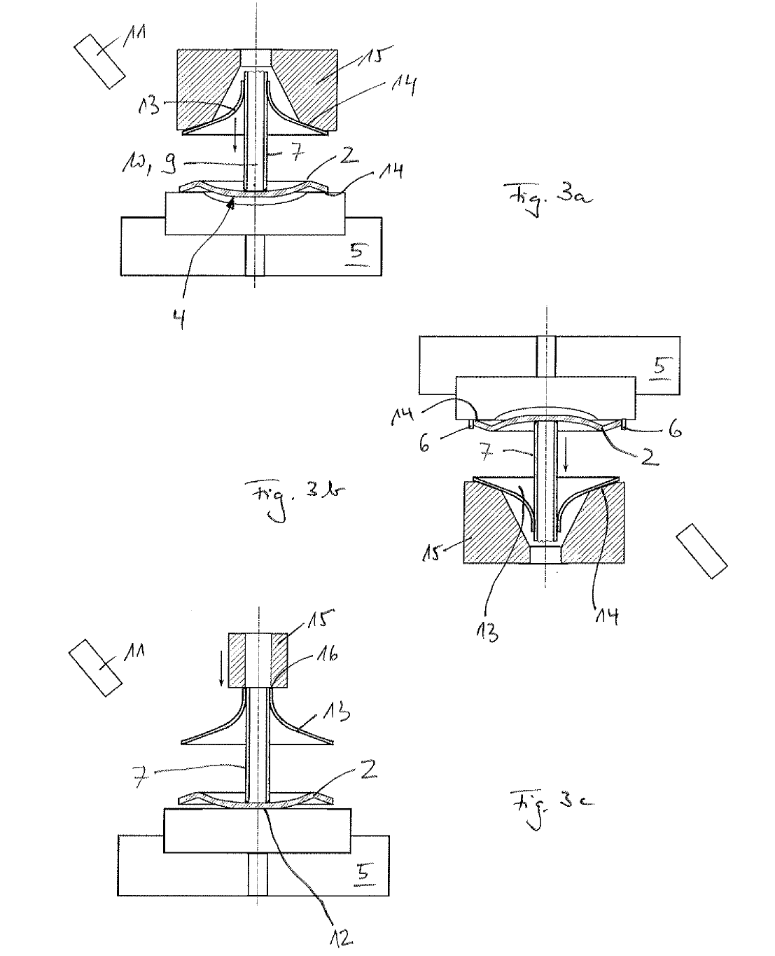

According to FIG. 2, the method step b.) following the method step a.) is now shown, in which the valve bottom 2 together with the valve stem 7 is rotated. During the rotating, the valve stem 7 is now welded together with the valve bottom 2 in the method step c.), for example by means of a laser 11. During the welding together, the valve bottom 2 in this case is supported in the mounting 4 in an inner, central region 12, so that in this case a support for a valve stem 7 is provided.

According to FIG. 2, the valve bottom 2 and the valve stem 7 in this case can be rotated while the laser 11 is stationary. Obviously, an inverted embodiment is likewise conceivable, in which the valve bottom 2 and the valve stem 7 are stationary and the laser 11 circulates for producing the welded seam joining the valve stem 7 to the valve bottom 2. The use of two lasers 11 is likewise conceivable, which are arranged opposite one another, so that in this case for producing a completely circumferential weld seam the valve stem 7 and the valve bottom 2 merely have to be rotated by 180° and not completely by 360°.

In a following method step c.), a valve cone 13 is now pushed over the valve stem 7 namely so far until it comes into contact with the valve bottom 2. To do so, there are various possibilities in principle.

According to FIG. 3a it is shown here that the valve cone 13 is pushed onto the valve stem 7 and in the process supports itself at an outer edge region 14 with respect to a holder 15. The valve bottom 2 in this case is likewise merely supported in an outer edge region 14.

FIG. 3b shows the method step b.) shown according to FIG. 3a with inerterd relative movement, so that in this case the valve stem 7 is pushed through the valve cone 13. Supporting both the valve cone 13 and also the valve bottom 2 in this case is analogously to FIG. 3a.

According to FIG. 3c by contrast, the valve bottom 2 is again supported in a middle central region 12, wherein the valve cone 13 is not supported in an outer edge region 14, but in the region of an inner edge region 16. Consequently, a force introduction which is entirely different from FIGS. 3a and 3b occurs.

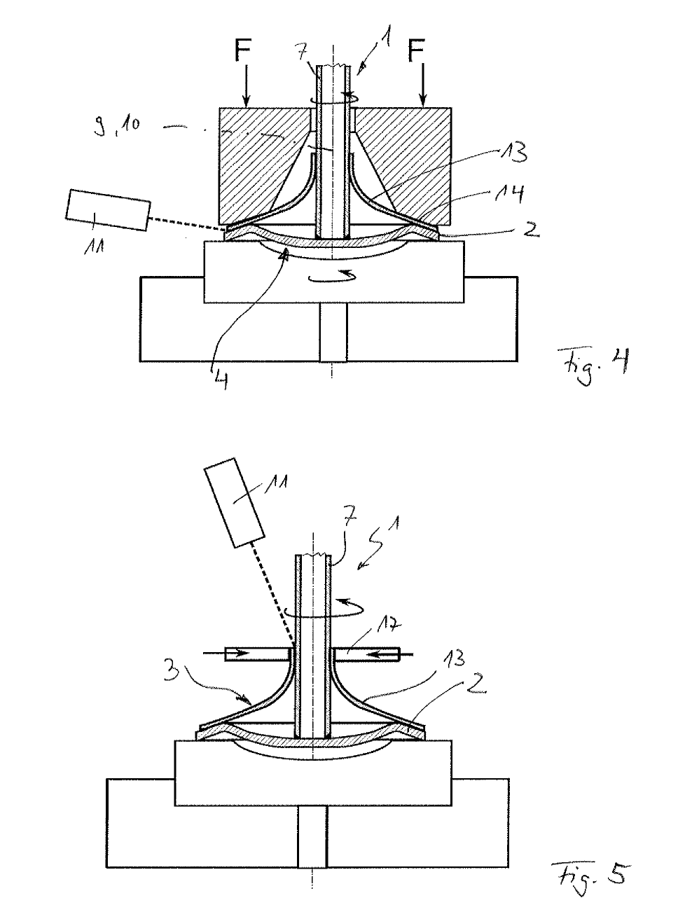

Looking at FIG. 4, the method step e.) of the method according to the invention is shown there, in which the valve cone 13 is welded together with the valve bottom 2 at an outer edge. In order to be able to create an exact weld seam in the process, the valve cone 13 is preloaded against the valve bottom 2. Welding in this case can be again carried out analogously to the possibilities described according to FIG. 2, so that either the laser 11 is stationary and the components 2, 13 to be welded are rotated or the laser 11 circulates along the weld seam and the components 2, 13 to be welded are stationary.

Finally, the method step f.) of the method according to the invention is shown in FIG. 5, in which the valve cone 13 is welded together with the valve stem 7. In order to be able to thereby likewise enforce producing of an exact weld seam, a clamping device 17 can be employed, which preloads the valve cone 13 against the valve stem 7 during the welding. Here, too, it is obviously conceivable that either the laser 11 circulates along the weld seam to be produced and the components to be welded together, i.e. in this case the valve cone 13 and the valve stem 7 are stationary, or that the last mentioned components 7, 13 are rotated so that in this case the laser 11 can be stationary. Here, too, the use of for example two lasers 11 is again conceivable, as a result of which the cycle time can be reduced.

With the method according to the invention the hollow valve 1 can be produced cost-effectively and with maximum precision, wherein it is conceivable that the method steps a.) to c.) is/are carried out in a first device (see FIGS. 1 and 2), the method steps d.) and e.) in a second device (see FIGS. 3 and 4) and the method step f.) in a third device (see FIG. 5).

1. A method for producing a hollow valve of an internal combustion engine, comprising:
providing a valve stem and a valve disc having a valve bottom and a valve cone;
placing the valve bottom centrally in a mounting of an assembly device,
holding the valve stem via a holding device,
concentrically placing the valve stem onto the valve bottom and rotating the valve stem together with the valve bottom,
welding the valve stem to the valve bottom,
pushing the valve cone over the valve stem until the valve stem contacts the valve bottom,
welding the valve cone together with the valve bottom, and
welding the valve cone together with the valve stem.

2. The method according to claim 1, wherein welding at least one of (i) the valve stem to the valve bottom and (ii) the valve cone to at least one of the valve bottom and valve stem takes place via at least one laser, the laser is stationary and rotating at least one of the valve stem, valve bottom and valve cone during the welding about the stationary laser forming an associated circumferential seam.

3. The method according to claim 1, wherein welding at least one of (i) the valve stem to the valve bottom and (ii) the valve cone to at least one of the valve bottom and valve stem takes place via at least one laser, and rotating the laser about at least one of the valve stem, valve bottom and valve cone during welding forming an associated circumferential seam.

4. The method according to claim 1, wherein welding includes two opposing lasers such that at least one of the valve stem, valve bottom and valve cone is rotated 180 degrees to produce an associated circumferential seam.

5. The method according to claim 1, wherein pushing the valve cone onto the valve stem includes supporting the valve cone and the valve bottom respectively on at least one of an outer edge region and an inner region.

6. The method according to claim 1, further comprising preloading the valve cone against the valve bottom during the step of welding the valve cone together with the valve bottom.

7. The method according to claim 1, wherein the steps of placing the valve bottom in the mounting, holding the valve stem, placing the valve stem onto the valve bottom, and welding the valve stem to the valve bottom are performed via a first device, the steps of pushing the valve cone over the valve stem and welding the valve cone together with the valve bottom are performed via a second device, and the step of welding the valve cone together with the valve stem is performed via a third device.

8. The method according to claim 2, wherein at least one of the steps of (i) welding the valve stem to the valve bottom, (ii) welding the valve cone to the valve bottom, and (iii) welding the valve cone to the valve stem includes two opposing lasers, and forming a circumferential seam in response to 180 degrees of relative rotation between the opposing lasers and the valve stem.

9. The method of claim 2, further comprising preloading the valve cone against the valve bottom during the step of welding the valve cone together with the valve bottom.

10. The method according to claim 3, wherein at least one of the steps of (i) welding the valve stem to the valve bottom, (ii) welding the valve cone to the valve bottom, and (iii) welding the valve cone to the valve stem includes two opposing lasers, and forming a circumferential seam in response to 180 degrees of relative rotation between opposing lasers and the valve stem.

11. The method according to claim 3, further comprising preloading the valve cone against the valve stem during the step of welding the valve cone together with the valve stem.

12. A method of manufacturing a hollow valve for an internal combustion engine, comprising:
providing a valve stem, a valve bottom and a valve cone;
mounting the valve bottom centrally in an assembly device;
arranging the valve stem concentrically onto the valve bottom;
joining the valve stem to the valve bottom to form a metallurgical joint encircling the valve stem;
inserting the valve stem through the valve cone until a periphery of the valve cone overlays a corresponding periphery of the valve bottom;
joining the valve cone together with the valve bottom; and
joining the valve cone together with the valve stem;

13. The method according to claim 12, wherein joining the valve stem to the valve bottom includes rotating the valve stem and the valve bottom relative to a stationary joining device.

14. The method according to claim 12, wherein joining the valve stem to the valve bottom includes rotating a joining device relative to the valve stem and valve bottom.

15. The method according to claim 12, further comprising preloading the valve cone against the valve bottom during the step of joining the valve cone together with the valve bottom.

16. The method according to claim 12, further comprising preloading the valve cone against the valve stem during the step of joining the valve cone together with the valve stem.

17. A method of assembling a hollow valve, comprising:
providing a hollow valve stem, a valve bottom having an outer edge, and a valve cone having an outer edge and an inner annular region defining an opening;
centring the valve bottom in a mounting;
abutting an end of the valve stem against the valve bottom, and aligning the valve stem concentrically with the valve bottom;
joining the valve stem with the valve bottom forming a metallurgical joint encircling the end of the valve stem;
inserting the valve stem through the opening of the valve cone, and abutting the outer edge of the valve cone against the outer edge of the valve bottom;
preloading at least one of (i) the valve cone against the valve bottom and (ii) the valve cone against the valve stem;
joining the outer edge of the valve cone with the outer edge of the valve bottom forming a metallurgical joint encircling the valve cone and valve bottom; and
joining the inner annular region of the valve cone with the valve stem forming an encircling metallurgical joint.

18. The method according to claim 17, wherein joining the valve stem with the valve bottom includes rotating the valve stem and the valve bottom relative to a stationary welding device.

19. The method according to claim 17, wherein at least one of the steps of (i) joining the valve stem with the valve bottom, (ii) joining the valve cone with the valve bottom, and (iii) joining the valve cone with the valve stem includes rotating a welding device circumferentially about the respective metallurgical joints.

20. The method according to claim 17, wherein at least one of the stems of (i) joining the valve stem with the valve bottom, (ii) joining the valve cone with the valve bottom, and (iii) joining the valve cone with the valve stem includes welding via two opposing lasers such that forming the associated encircling metallurgical joint occurs in response to 180 degrees of relative rotation between the opposing lasers and the valve stem.
